(19) United States
(12) Patent Application Publication
(10) Pub. No.: US 2024/0062113 A1
(43) Pub. Date: Feb. 22, 2024

(54) SYSTEMS AND METHODS FOR SCALABLE AND FLEXIBLE FEDERATED LEARNING FRAMEWORKS

(71) Applicant: JPMORGAN CHASE BANK, N.A., New York, NY (US)

(72) Inventors: Fanny SILAVONG, London (GB); Shaltiel ELOUL, London (GB); Antonios GEORGIADIS, London (GB); Sanket KAMTHE, London (GB); Sean MORAN, London (GB)

(21) Appl. No.: 18/452,010

(22) Filed: Aug. 18, 2023

(30) Foreign Application Priority Data
Aug. 19, 2022 (GR) 20220100699

(51) Int. Cl. G06N 20/00; H04L 9/40

(52) U.S. Cl. CPC G06N 20/00; H04L 63/04

(57) ABSTRACT

Systems and methods for scalable and flexible federated learning frameworks are disclosed. A method may include: (1) receiving, by a computer program executed by an electronic device and from a client, a project for federated learning using a training federation, the training federation comprising a plurality of clients; (2) generating, by the computer program, a configuration file that reflects a set-up for the training federation; (3) receiving, by the computer program, files necessary to build containers, wherein at least some of the files are customized by the client; (4) generating, by the computer program, containers comprising the configuration file and files necessary to build the containers; and (5) deploying, by the computer program, the containers to a client compute environment for the client as a client node, wherein the client node is configured to join the training federation as a server and/or a participant.

### RELATED APPLICATIONS

This application claims priority to, and the benefit of, Greek Patent Application No. 20220100699, filed Aug. 19, 2022, the disclosure of which is hereby incorporated, by reference, in its entirety.

### BACKGROUND OF THE INVENTION

### 1. Field of the Invention

Embodiments relate generally to systems and methods for scalable and flexible federated learning frameworks.

### 2. Description of the Related Art

In the traditional setting, data has to be moved to a single location for machine learning to take place. With the changing data privacy landscape and data protection regulations (e.g., GDPR), data movement is becoming increasingly more difficult. Federated Learning allows machine learning models to be trained across data silos without moving or revealing data.

### SUMMARY OF THE INVENTION

Systems and methods for scalable and flexible federated learning frameworks are disclosed. In one embodiment, a method for initiating a scalable and flexible federated learning framework may include: (1) receiving, by a computer program executed by an electronic device, a project for federated learning using an active training federation; (2) receiving, by the computer program, entry points; (3) receiving, by the computer program, a training set-up in a configuration file; (4) calling, by the computer program, deployed containers/computer programs for active training configurations; (5) building, by the computer program, a federated learning architecture using the entry points, the configuration file, the active training configurations, a user defined model into a container; (6) deploying, by the computer program, the container; (7) and joining, by the computer program, an active training federation.

According to another embodiment, a method may include: (1) receiving, by a computer program executed by an electronic device and from a client, a project for federated learning using a training federation, the training federation comprising a plurality of clients; (2) generating, by the computer program, a configuration file that reflects a set-up for the training federation; (3) receiving, by the computer program, files necessary to build containers, wherein at least some of the files are customized by the client; (4) generating, by the computer program, containers comprising the configuration file and files necessary to build the containers; and (5) deploying, by the computer program, the containers to a client compute environment for the client as a client node, wherein the client node may be configured to join the training federation as a server and/or a participant.

In one embodiment, the client joins the training federation by registering with an orchestrator on a server backend, receiving server weights from the server, local training a client model with the server weights, and sending weight deltas based on the local training to the server backend.

In one embodiment, the configuration file may include a modifiable template.

In one embodiment, the computer program further generates the container based on a user defined model.

In one embodiment, the user defined model specifies a machine-learning model for the training federation.

According to another embodiment, a method may include: (1) receiving, by a computer program executed by an electronic device and from a client, a project for federated learning; (2) generating, by the computer program, a configuration file that reflects a set-up; (3) determining, receiving, by the computer program, that there is an active training federation for the project comprising a plurality of clients; (4) receiving, by the computer program, an active training configuration for the active training federation; (5) receiving, by the computer program, files necessary to build containers, wherein at least some of the files are customized by the client; (6) generating, by the computer program, containers comprising the configuration file, the active training configuration, and files necessary to build the containers; and (7) deploying, by the computer program, the containers to a client compute environment for the client as a client node, wherein the client node may be configured to join the active training federation as a server and/or as a client participant.

In one embodiment, the client node may be configured to join the active training federation in response to a starting condition being met.

In one embodiment, the starting condition may include two or more client nodes being participants in the active training federation.

In one embodiment, the client joins the active training federation by registering with an orchestrator on a server backend, receiving server weights from the server backend, local training a client model with the server weights, and sending weight deltas based on the local training to the server backend.

In one embodiment, the active training configurations comprise an API format expectation and metadata about nodes in the active training configuration.

In one embodiment, the method may also include: receiving, by the computer program, entry points for the active training federation; wherein the configuration file may include the entry points.

According to another embodiment, a method may include: (1) receiving, by a computer program executed by an electronic device and from a client, a project for federated learning; (2) generating, by the computer program, a configuration file that reflects a set-up; (3) determining, receiving, by the computer program, that there is not an active training federation for the project; (4) receiving, by the computer program, an active training configuration for the active training federation; (5) receiving, by the computer program, files necessary to build containers, wherein at least some of the files are customized by the client; (6) generating, by the computer program, an architecture comprising the configuration file, the active training configurations, and files necessary to build containers for the training federation; and (7) deploying, by the computer program, the containers to a client compute environment for the client as a client node, wherein the client node may be configured to build an architecture for the training federation and join the federation as a server and/or as a client participant.

In one embodiment, the client node may be configured to join the training federation in response to a starting condition being met.

In one embodiment, the starting condition may include two or more client nodes being participants in the training federation.

In one embodiment, the client joins the training federation by registering with an orchestrator on a server backend, receiving server weights from the server backend, local training a client model with the server weights, and sending weight deltas based on the local training to the server backend.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for scalable and flexible federated learning frameworks according to an embodiment;

FIGS. 2a-c illustrate examples of federated learning use cases;

FIG. 3 depicts how embodiments support under supported architecture yet have high potential according to embodiments;

FIG. 4 depicts a horizontal federated learning setup according to an embodiment;

FIG. 5 depicts a complex federated learning setup according to an embodiment;

FIG. 6 depicts a method for scalable and flexible federated learning frameworks according to an embodiment;

FIG. 7 depicts a method for scalable and flexible federated learning frameworks according to another embodiment; and

FIG. 8 depicts an exemplary computing system for implementing aspects of the present disclosure.

### DETAILED DESCRIPTION OF PREFERRED EMBODIMENTS

Embodiments relate generally to systems and methods for scalable and flexible federated learning frameworks. Specifically, embodiments may provide a lightweight and highly flexible federated learning framework. Embodiments may provide the ability to choose one of a plurality of architectural designs that may account for growing federation architectures and industry applications.

Embodiments may also provide mechanisms for monitoring and flagging private data leakage, techniques for improving the generalization capability of federated learning, and methods for processing highly confidential text-based data in a federation.

Embodiments may forgo traditional formal definitions of a server, a participant (i.e., a client to the federation), and an aggregator to account for the growing number of federated learning patterns. Thus, embodiments may see each federation participant as a node in a network, where each node is considered as its own entity with full control of its own federation. This provides the ability for one node to participate in multiple federations.

Embodiments may provide some or all of the following: local simulation, distributed computing, containerized, agnostic to machine learning (ML) Framework, full architecture flexibility, built-in privacy protection, dynamic participation in active federations, etc.

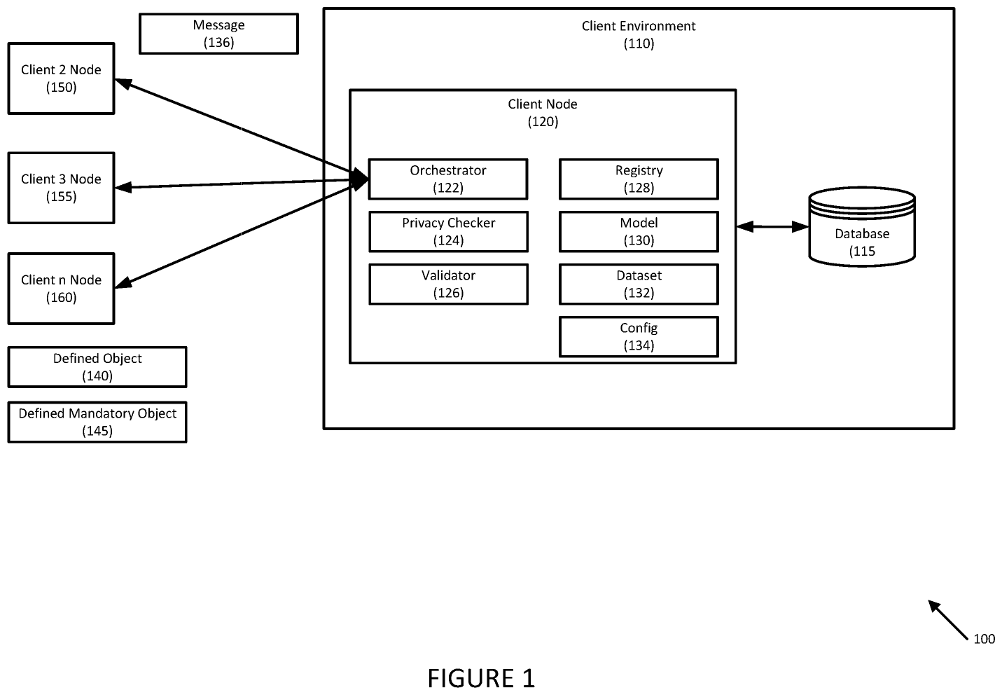

Referring to FIG. 1, a system for scalable and flexible federated learning frameworks is disclosed according to an embodiment. System 100 may include client environment 110 with client node 120. Client environment 110 may be a compute environment for a client that can spin up one or more client nodes 120. Client node 120 may include several objects or modules, including orchestrator 122, privacy checker 124, validator 126, registry 128, model 130, dataset 132, and configuration (“config”) 134.

In one embodiment, nodes 120, 150, 155, 160 may be virtual machines.

Orchestrator 122 may coordinate the federation from the perspective of node 120; specifically, it may trigger the core functions of each object in a defined sequence. Orchestrator 122 may receive and pass incoming message objects to a queue for downstream tasks, and may send outgoing message objects to other nodes 150, 155, 160 based on registry 128. Orchestrator 122 may be the only manner for client node 120 to communicate with elements in the external environment, such as client 2 node 150, client 3 node 155, client n node 160, etc.

Registry 128 may control which nodes 120, 150, 155, 160 and what information the node(s) should communicate with each other. In vertical federated learning, registry 128 may store the owner of partial gradients and facilitate the communication process ensuring the construction of the entire model is intact.

Embodiments may allow dynamic updates to the list of registered nodes, thereby enabling re-routing and adding, modifying, and/or deleting nodes. For example, a new node (e.g., 120, 150, 155, 160, etc.) may join an active federation by making an API call to orchestrator 122, which may register the node as collaborators with the necessary federation information required by the federation.

An example of a registry payload is provided below:

```
{
  “ip_address”: “0 . 0 . 0 . 0” ,
  “requests” : [ {
    ‘participation_type’: ‘publish’,
    ‘operation’: ‘add’,
    ‘payload’:[ ]
    },{
      ‘participation_type’: ‘subscribe’,
      ‘operation’: ‘add’,
      ‘payload’ [ ]
  }]
}
```

The payload is designed to communicate the expected payload, such as the specific layer in the case of vertical federated learning.

Model object 130 may be the base abstract class with abstract methods to update the underlying machine learning model. It may produce and consume messages that orchestrator 122 receives (or sends) to other nodes (e.g., 150, 155, 160, etc.). Clients may use model object 130 as the base to create their federated model. For instance, clients may leverage update function to define when it should update the underlying model after receiving n shared gradients.

An example of an abstract model object is provided below:

```
class Model (ABC) :
  def _ _init _ _ (self, config, registry):
    self.config = config
    self.registry = registry
  @abstractmethod
  def update (self):
    “““Receive the Message from
      other nodes and process them. ”””
          pass
  @property
  @abstractmethod
  def trainable_variables (self):
    pass
  @property
  @abstractmethod
  def non_trainable_variables (self):
    pass
  @property
  def weights (self):
    return ModelWeights(
        trainable=self.trainable_variables,
        non_trainable=self.nontrainable_variables)
  def weights_to_byte (self):
    “““Method to serialize weights ”””
        msg = Message ( )
        msg.weights = self.to_byte (self.weights)
        return [msg ]
  @staticmethod
  def to_byte (obj) :
    return pickle.dumps ( obj )
```

Dataset object 132 may be the base abstract class with defined methods to track data usage. Dataset object 132 may enable other objects, such as privacy checker 124, validator 126, and/or other objects to examine and leverage the dataset used for training.

Message object 136 may be a base abstract class with abstract methods to construct a communication message. Messages 136 may be consumed and shared by orchestrator 122, and its content may be passed to other objects, such as privacy checker 124 and model object 130. Message 136 may be an object containing the information necessary for federated learning to take place.

Config object 134 may be a base abstract class with defined methods to consume user-defined configuration and derived configuration. Config object 134 may be consumed by all objects as it may contain essential information.

Privacy checker object 124 may be a base abstract class with defined methods to examine the federation, check if any privacy leakage, return a policy to minimize privacy leakage and/or control leakage under a user-defined threshold.

Each node 120, 150, 155, 160, etc. may have two communication channels: one to send (or publish) messages, and one to receive (or subscribe to) messages. Based on registry 128, nodes 120, 150, 155, 160, etc. may send and receive messages to one another to exchange information required for learning to take place. The framework may be agonistic to the communication protocol—for example, it may support HTTP/TCP and other protocols.

Validator 126 may validate whether the objects in message 136 that are shared contain the necessary information in the expected format. Validator 126 may be optional.

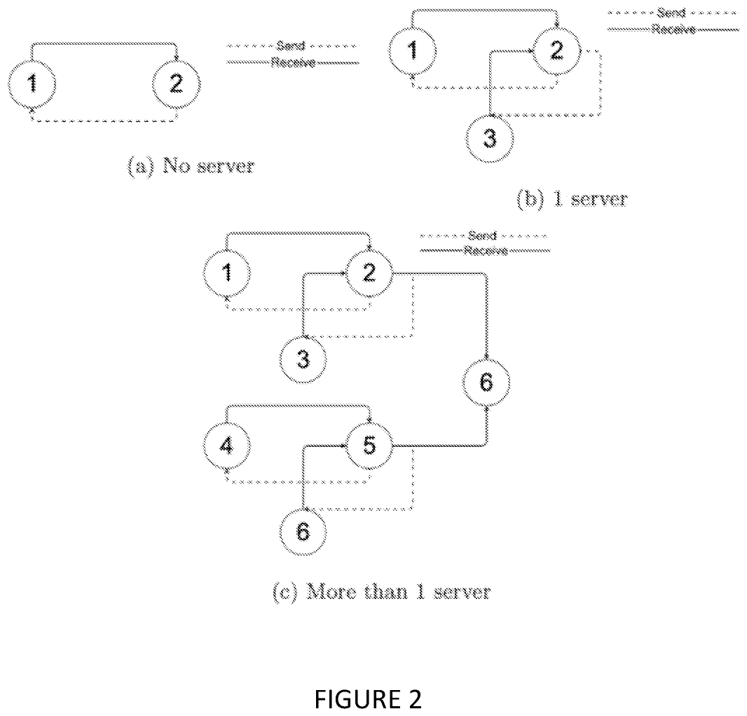

FIGS. 2a-c illustrate examples of federated learning use cases. FIG. 2a depicts two participants. FIG. 2b depicts horizontal federated learning, with one server and multiple clients. In embodiments, this translates to one server node that sends message to and receive message from registered client nodes. Multiple aggregators may be required to handle situations where there are many clients devices such as FIG. 2c. FIG. 2c may be achieved with node addition and communication channels reroute in the registry.

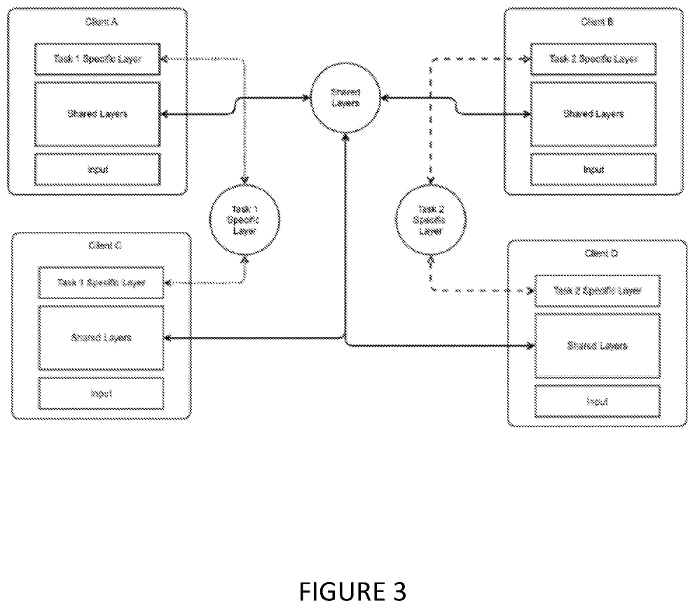

FIG. 3 illustrates how embodiments support under supported architecture yet high potential—Federated Multi-Task Learning, and addresses the split learning paradigm as shown in FIG. 2a with two participants. For example, FIG. 3 illustrates a situation where all participants are jointly learning a foundational model and learning task specific layers between groups of participants (e.g., Client A and Client C, as well as Client B and Client D).

Messages may be used to share the aggregated weights for horizontal federated learning and partial weights for vertical federated learning.

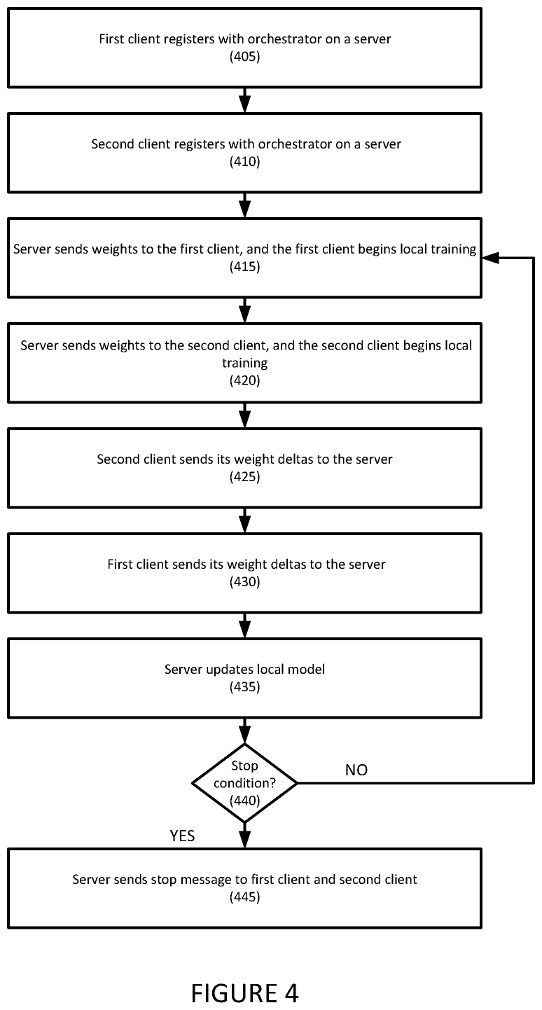

FIG. 4 depicts a method for horizontal federated learning setup according to an embodiment. In one embodiment, the method of FIG. 4 may be used for local federated learning with multiple nodes.

In step 405, a first client may register with an orchestrator on a server. For example, the first client may share its address, participation type, and any other information that may be necessary and/or desired in order to request participation in the federation.

In step 410, a second client may register with the orchestrator. This may be similar to step 405.

Once local training is initiated, in step 415, the server may send weights to the first client, and the first client may begin local training.

In step 420, the server may send weights to the second client, and the second client may begin local training.

In step 425, at the conclusion of local training, the second client may send its data, such as its weight deltas, to the server.

In step 430, at the conclusion of local training, the first client may send its data, such as its weight deltas, to the server.

In step 435, the server may update the local model, steps 415-435 may be repeated until, in step 440, a condition is met, such as a change in the model at the server is below a threshold. When that happens, in step 445, the server may send a stop message to the first client and to the second client.

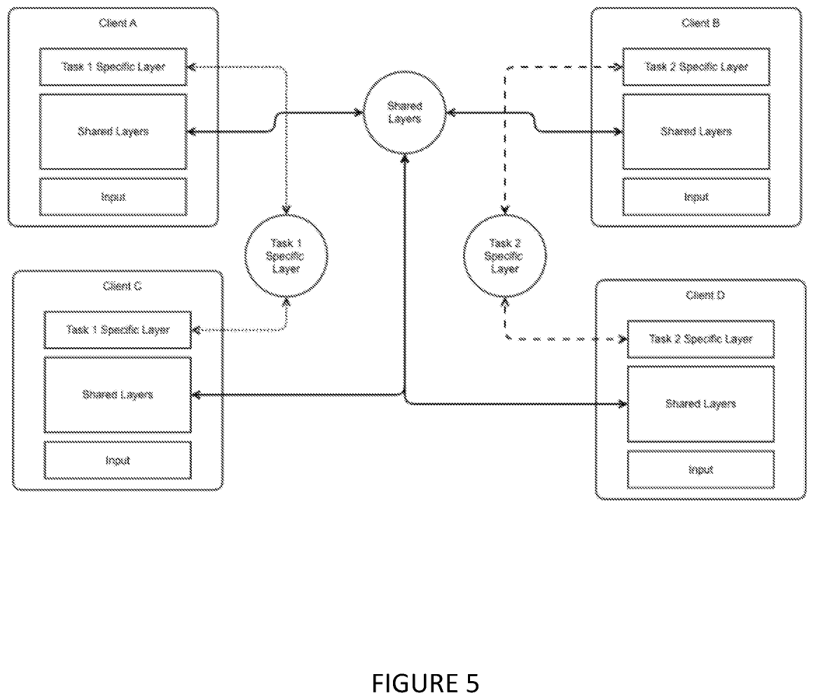

FIG. 5 depicts a complex federated learning setup according to an embodiment. Like FIG. 3, FIG. 5 illustrates a situation where all participants are jointly learning a foundational model and learning task specific layers between groups of participants (e.g., Client A and Client C, as well as Client B and Client D).

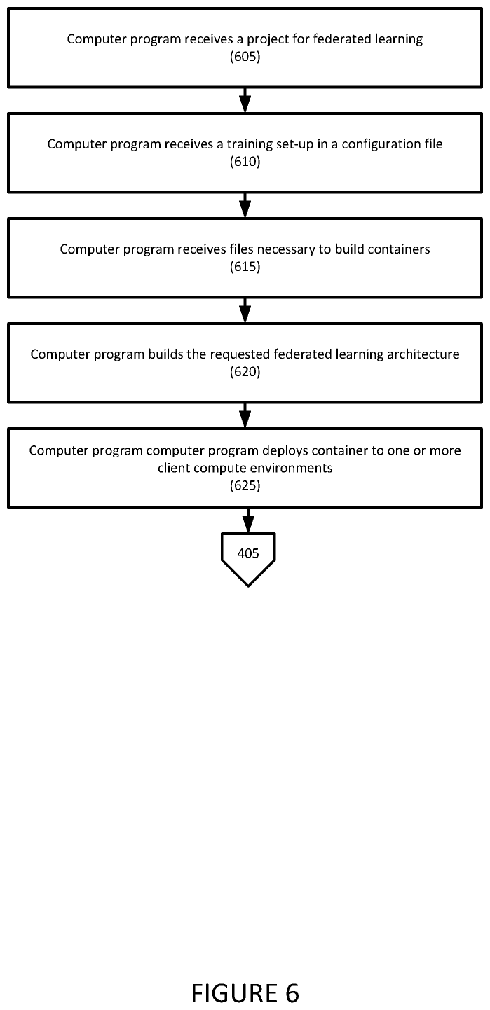

Referring to FIG. 6, a method for scalable and flexible federated learning frameworks is disclosed according to another embodiment. In FIG. 6, a single device may construct all node architectures, may run local tests, and may deploy to multiple devices that will use real data from its respective locations. In one embodiment, the method may be centralized in which one node is considered to be the “server,” or decentralized, where all nodes are considered to be “servers.”

In step 605, a computer program at a node may receive a project for federated learning. For example, the computer program may contain the necessary tools/flows for users to train their models in a federation fashion with or without other users.

The project may be received from source code.

In step 610, the computer program may generate a configuration file that reflects the federation set up for local testing. For example, the configuration file may include entry point(s) and a training set-up in, for example, a j son file.

In step 615, the computer program may receive the files necessary to build multiple containers for local testing. In one embodiment, the computer program may generate a template that may be modified by the user to reflect the desired federation set up. For example, the client may define the model, privacy protection, aggregation techniques, optimization, encryption, etc. for the desired federated learning architecture.

In step 620, the computer program may build the requested federated learning architecture into a container using the entry point(s), the configuration file, active training configuration, a user defined model, other objects (e.g., a privacy checker, a validator, etc.) and the files necessary to build multiple containers.

In step 625, the computer program may deploy the containers to one or more client compute environments as client nodes. The client compute environments may then build the container(s) within its environment.

Once the container(s) are built, embodiments may begin federated learning using, for example, the process of FIG. 4. For example, embodiments may start with step 405.

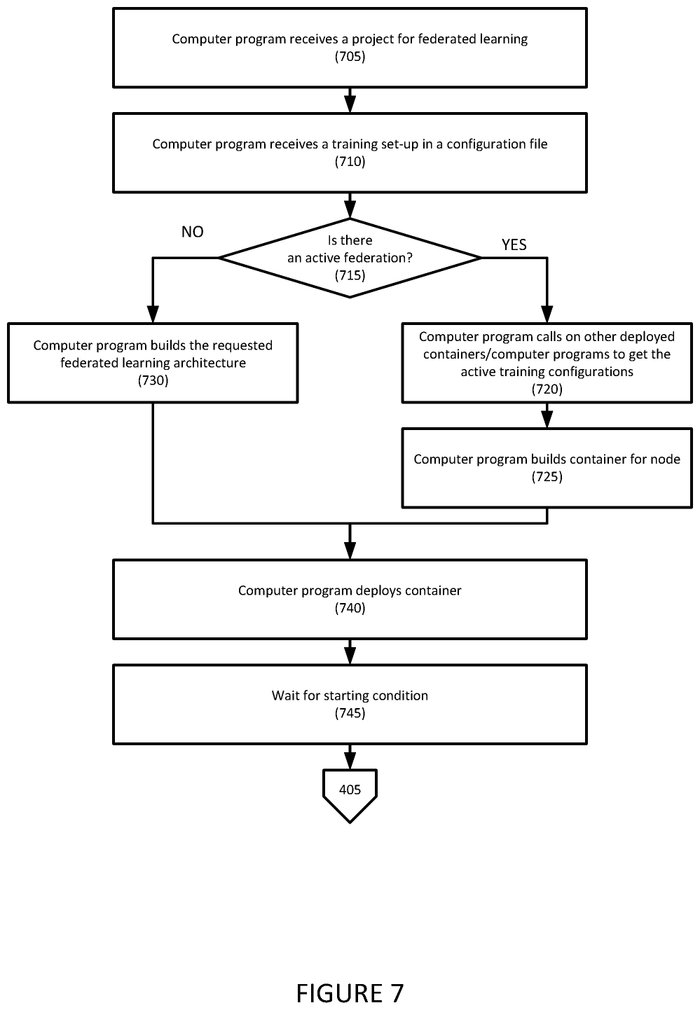

Referring to FIG. 7, a method for scalable and flexible federated learning frameworks is disclosed according to another embodiment. In FIG. 7, each device/node may construct its own architecture, may deploy in its environment, and may communicate across environments for federated learning to take place.

In step 705, a computer program may receive a project for federated learning. This may be similar to step 605, above.

In step 710, the computer program may receive a training set-up in a configuration file. For example, the configuration file may include entry point(s) and a training set-up in, for example, a json file.

In step 715, the computer program may determine if there is an active federation to join. For example, the computer program may receive an indication from the client that it is to join an active federation.

If there is not an active federation to join, the process may continue with step 725.

If there is an active federation to join, in step 720, the computer program may call on other deployed containers/computer programs to receive the active training configuration. For example, the computer program may receive information on the API format expectation, and metadata about the active federation, etc.

In step 725, the computer program may build a container for a node for the client.

If there is not an active federation, in step 730, the computer program may build the requested federated learning architecture using the entry points, the configuration file, the user defined model and other objects into a container.

In step 740, the computer program may deploy the container.

In step 745, the computer program may wait for a starting condition to be met before starting a federation or joining the active federation. The node may act as a server and/or a participant. For example, a starting condition may be two or more nodes joining the federation. Once the starting condition is met, embodiments may begin federated learning using, for example, the process of FIG. 4. For example, embodiments may start with step 405.

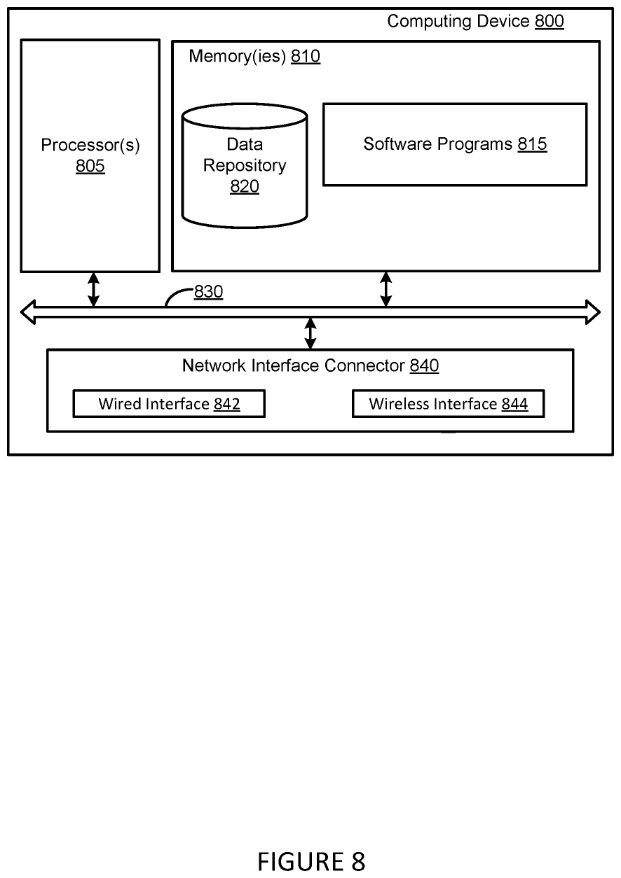

FIG. 8 depicts an exemplary computing system for implementing aspects of the present disclosure. FIG. 8 depicts exemplary computing device 800. Computing device 800 may represent the system components described herein. Computing device 800 may include processor 805 that may be coupled to memory 810. Memory 810 may include volatile memory. Processor 805 may execute computer-executable program code stored in memory 810, such as software programs 815. Software programs 815 may include one or more of the logical steps disclosed herein as a programmatic instruction, which may be executed by processor 805. Memory 810 may also include data repository 820, which may be nonvolatile memory for data persistence. Processor 805 and memory 810 may be coupled by bus 830. Bus 830 may also be coupled to one or more network interface connectors 840, such as wired network interface 842 or wireless network interface 844. Computing device 800 may also have user interface components, such as a screen for displaying graphical user interfaces and receiving input from the user, a mouse, a keyboard and/or other input/output components (not shown).

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program executed by an electronic device and from a client, a project for federated learning using a training federation, the training federation comprising a plurality of clients;
generating, by the computer program, a configuration file that reflects a set-up for the training federation;
receiving, by the computer program, files necessary to build containers, wherein at least some of the files are customized by the client;
generating, by the computer program, containers comprising the configuration file and files necessary to build the containers; and
deploying, by the computer program, the containers to a client compute environment for the client as a client node, wherein the client node is configured to join the training federation as a server and/or a participant.

2. The method of claim 1, wherein the client joins the training federation by registering with an orchestrator on a server backend, receiving server weights from the server, local training a client model with the server weights, and sending weight deltas based on the local training to the server backend.

3. The method of claim 1, wherein the configuration file comprises a modifiable template.

4. The method of claim 1, wherein the computer program further generates the container based on a user defined model.

5. The method of claim 4, wherein the user defined model specifies a machine-learning model for the training federation.

6. A method, comprising:
receiving, by a computer program executed by an electronic device and from a client, a project for federated learning;
generating, by the computer program, a configuration file that reflects a set-up;
determining, receiving, by the computer program, that there is an active training federation for the project comprising a plurality of clients;
receiving, by the computer program, an active training configuration for the active training federation;
receiving, by the computer program, files necessary to build containers, wherein at least some of the files are customized by the client;
generating, by the computer program, containers comprising the configuration file, the active training configuration, and files necessary to build the containers; and
deploying, by the computer program, the containers to a client compute environment for the client as a client node, wherein the client node is configured to join the active training federation as a server and/or as a client participant.

7. The method of claim 6, wherein the client node is configured to join the active training federation in response to a starting condition being met.

8. The method of claim 7, wherein the starting condition comprises two or more client nodes being participants in the active training federation.

9. The method of claim 6, wherein the client joins the active training federation by registering with an orchestrator on a server backend, receiving server weights from the server backend, local training a client model with the server weights, and sending weight deltas based on the local training to the server backend.

10. The method of claim 6, wherein the active training configurations comprise an API format expectation and metadata about nodes in the active training configuration.

11. The method of claim 6, further comprising:
receiving, by the computer program, entry points for the active training federation;
wherein the configuration file comprises the entry points.

12. A method, comprising:
receiving, by a computer program executed by an electronic device and from a client, a project for federated learning;
generating, by the computer program, a configuration file that reflects a set-up;
determining, receiving, by the computer program, that there is not an active training federation for the project;
receiving, by the computer program, an active training configuration for the active training federation;
receiving, by the computer program, files necessary to build containers, wherein at least some of the files are customized by the client;
generating, by the computer program, an architecture comprising the configuration file, the active training configurations, and files necessary to build containers for the training federation; and
deploying, by the computer program, the containers to a client compute environment for the client as a client node, wherein the client node is configured to build an architecture for the training federation and join the federation as a server and/or as a client participant.

13. The method of claim 12, wherein the client node is configured to join the training federation in response to a starting condition being met.

14. The method of claim 13, wherein the starting condition comprises two or more client nodes being participants in the training federation.

15. The method of claim 12, wherein the client joins the training federation by registering with an orchestrator on a server backend, receiving server weights from the server backend, local training a client model with the server weights, and sending weight deltas based on the local training to the server backend.
